(19) United States
(12) Patent Application Publication
(10) Pub. No.: US 2002/0077892 A1
(43) Pub. Date: Jun. 20, 2002

(54) Graphical coupon for service providers

(76) Inventor: Bryan R. Goring, Mississauga (CA)

Correspondence Address: COBRIN & GITTES, 750 Lexington Avenue, 21 Floor, New York, NY, 10022, US

(21) Appl. No.: 09/738,725

(22) Filed: Dec. 15, 2000

(51) Int. Cl. G06F 17/60

(52) U.S. Cl. 705/14

(57) ABSTRACT

A system and method are provided for configuring and printing graphical coupons and/or receipts. The invention makes use of the ability of conventional receipt printers to print in a bit image mode. Most receipt printers (e.g., thermal printers, swecoin printers, etc.) are capable of providing a printed scanline composed of individual pixels that can be turned on or off. By printing several scanlines in succession or in alternating succession with specified pixels turned on and/or off, the printer may be employed to print high-resolution or low-resolution images (e.g. logos, pictures, coupons, etc.). Thus content providers (e.g. merchants, service providers, etc.) will have the ability to provide text, images or a combination of the two on each printed receipt

### TECHNICAL FIELD

The invention relates generally to printed coupons and receipts and more particularly to creating printed coupons and receipts, which include printed images.

### BACKGROUND

It is said that a picture is worth a thousand words. However, conventional receipts and printed coupons are printed without pictures (images). They are entirely character based and are limited to the printers available character set (generally a subset of ASCII). Thus, conventional printed receipts and coupons are limited in the amount of information and in the advertising impact they provide. Because they are entirely character based, consumers generally discard printed coupons or receipts without determining the merchant's name and without gaining a lasting impression of the merchant.

In an attempt to provide images and more interesting receipts, some manufacturers have preprinted coupons on the receipt paper. This however requires double printing and does not target the advertisement (coupon or receipt) to interested consumers. For example, a consumer could go to the market to purchase milk and the receipt is preprinted with an advertisement or coupon for shampoo. The only nexus between the item purchased and the item advertised is that each is sold in the same large store.

It would be advantageous to provide the ability to print images on printed coupons and/or receipts. It would also be advantageous to print coupons/receipts that are targeted to the consumer.

### BRIEF DESCRIPTION OF THE DRAWINGS

FIG. 1 illustrates a block diagram of an embodiment of the present invention.

FIG. 2 illustrates a coupon/receipt printed with a fixed graphic in accordance with the invention illustrated in FIG. 1.

FIG. 3 illustrates a coupon/receipt printed with a floating image in accordance with the invention illustrated in FIG. 1.

### SUMMARY

The present invention provides a customizable Internet advertising method for configuring and printing images on printed coupons and receipts. It provides a method of advertising by printing images on a receipt or coupon. The method includes downloading graphics information from a database, retrieving an image associated with the image information, converting the image into grayscale, converting the grayscale image into dithered black-and-white pixels, converting the dithered pixels into a pixel matrix representation, and printing at least one scan line. The scan line is printed by selectively printing pixels corresponding to the pixel matrix representation.

The invention also provides a method of printing a receipt which includes a printed image. The method includes downloading transaction information, retrieving an image associated with the transaction information, converting the image into a pixel matrix representation, and printing at least one scan line. The scan line is printed by selectively printing pixels corresponding to the pixel matrix representation.

The invention provides apparatus for receipt generation. The apparatus includes a coupon generator in communication with an input port of the apparatus configures to receive and process purchase information relating to a transaction. The coupon generator provides at least one index pointer responsive to the purchase information. Th eapparatus also includes a coupon image database having accessible various coupon fields for storage and retrieval of coupon images. The coupon generator incorporates a related coupon image with the purchase information for transmission to an output port of the apparatus.

The invention further provides a method of printing a coupon which includes a printed image. The method includes monitoring transaction information, retrieving an image associated with the transaction information, converting the image into a pixel matrix representation, and printing at least one scan line. The scan line is printed by selectively printing pixels corresponding to the pixel matrix representation.

The invention also provides a system for printing a coupon or receipt which includes a printed image. The system includes a work station that is capable of connecting to a network. Connected to the workstation is a printer. Loaded on the work station is software that is configured to download image information from a remote location, and convert an image associated with the image information into a pixel matrix representation. The printer is configured to print at least one scan line by selectively printing pixels corresponding to the pixel matrix representation.

### DETAILED DESCRIPTION

The present invention provides a method for configuring and printing images on printed coupons and receipts. The invention makes use of the ability of conventional receipt printers to print in a bit image mode. Most receipt printers (e.g., thermal printers, swecoin printers, dot matrix printers, etc.) are capable of providing a printed scanline composed of individual pixels that can be turned on or off. By printing several scanlines in succession or in alternating succession with specified pixels turned on and/or off, the printer may be employed to print high-resolution or low-resolution images (e.g. logos, pictures, a coupon, etc.). Thus content providers (e.g. merchants, service providers, etc.) will have the ability to provide text, images, or a combination of the two on each printed receipt or coupon.

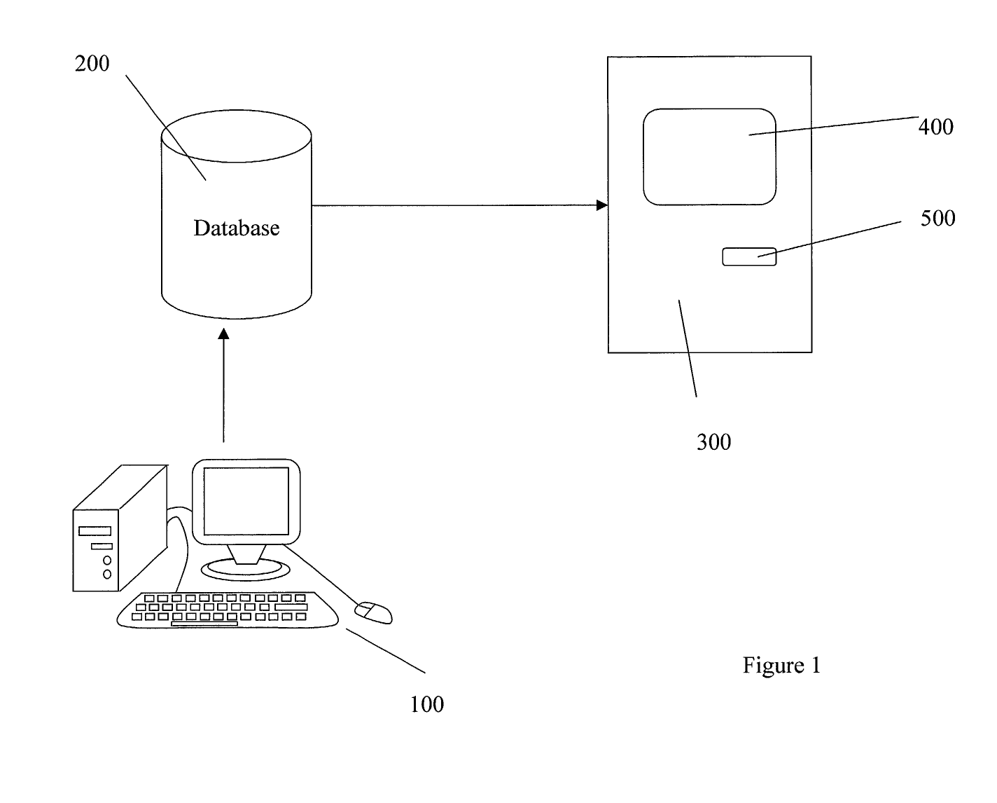

FIG. 1 illustrates an embodiment of the present invention. A content provider may develop image information and store it in a file (e.g. a bit-mapped image file, a Joint Photographic Experts Group (“JPEG”) file, Tagged Image File Format (“TIFF”) file, or any other image file). The desired image information can be provided through the Internet or some other accessible network, or it may be provided directly at the workstation 300. The images may be developed through image design applications (e.g. Microsoft Paint, etc.) which allow greater printed-image control for more intricate images. In comparison, conventional receipts and printed coupons have at most a series of graphics characters, such as those from the IBM extended character set, limiting the amount of information and the advertising impact they provide.

Once the image information is stored, either locally or through a Universal Resource Locator (URL) also known as an Internet address, an image database 200 may be established. Those skilled in the art can appreciate that the system is not limited to employing a database. Other storage structures may be employed, such as a linking table, etc. The database 200 can provide a link between a selected image file, or a URL, service provider information. Service provider information may include the trade name of the service provider/merchant (e.g. Nortel Networks™, Foot Locker™, etc.), word associations (e.g. goods: telephones, modems, fiber optics, sneakers, shoes, socks, etc., services: switching, manufacturing, etc., website: nortelnetworks.com, footlocker.com, etc.), placement of the image on a customer receipt (e.g. fixed or floating), associates and/or competitors of the merchant/service provider (e.g. Nike™, Reebok™, etc.) and coupon amount.

During operation a consumer accesses the Internet or some other network using a kiosk 300. The kiosk 300 may have a display 400, other input devices (e.g. a keyboard, mouse, etc.) a printer 500, and other output devices. The printer 500 may be integrated with the kiosk 300, or it may be an adjunct thereto.

Kiosk 300 is generally configured to support only certain services. Kiosk 300 may communicate with database 200 and thus download images which are linked to the supported services. While it may be possible to perform this function in real time, it is preferable to perform the download during startup and/or during regular idle check in periods. Those skilled in the art will recognize that kiosk 300 need not be limited to printing receipts and/or coupons for supported services and may provide the option for graphical printed receipts and/or coupons for all services.

After a consumer selects one of the supported services and performs a financial transaction (e.g. a purchase, a bank withdrawal, paying a bill on-line, etc.), the kiosk 300 processes the financial transaction, sends the results to the service provider and receives the receipt details. The kiosk 300 then produces a receipt with the included graphic (e.g. the merchants logo may be printed at the top of each receipt). If the receipt is a Token receipt (one in which the format is fixed), the kiosk 300 receives the Token receipt details and prints a fixed graphic in a preassigned location on the Token receipt. There is no need to specify the graphic since the file name and placement should already be known by the kiosk 300. However, the system may be configured to require that the service provider specifies the graphic and its location (e.g. header, footer, margin, specific box, etc.). This could be done for redundancy purposes (in which case the kiosk 300 could either print the graphic based on the stored information or based on the received information depending on the design choice) or it could be done to allow services, which are not specific to the kiosk 300 to utilize the graphical receipt capabilities.

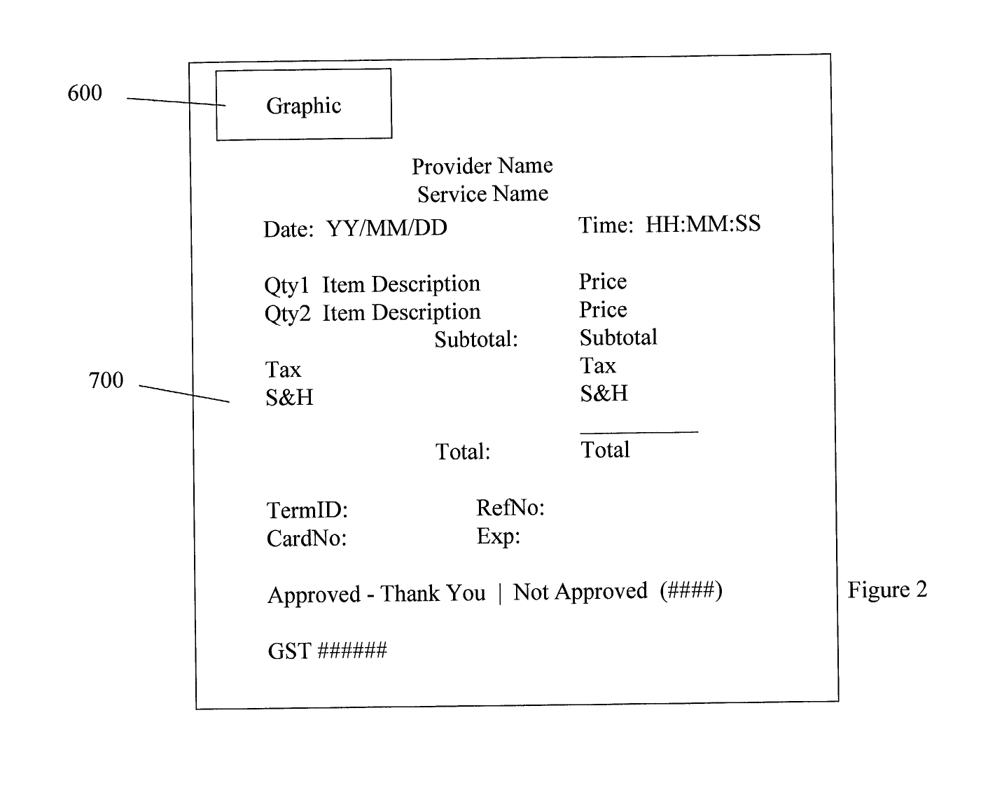

In an embodiment of the invention, after a consumer selects one of the supported services and performs a transaction (e.g. a purchase, a bank withdrawal, paying a bill on-line, etc.), the kiosk 300 provides a coupon generator capability that processes information from the transaction, sends the results to the service provider and receives the receipt details (transaction information). The receipt details, provided by the service provider, can be stored in the database 200 for later retrieval to aid in the efficiency of the process. The kiosk 300 then produces a receipt 700 (FIG. 2) with an image of a coupon included therein. In this manner, the coupon is incorporated with the physical receipt, providing additional information upon redemption of the coupon, such as the origination location of the coupon. This information may be employed to assess a marketing campaign effectiveness, etc.

If the receipt is a Token receipt (one in which the format is fixed), the kiosk 300 receives the Token receipt details and prints a fixed image 600 in a preassigned location on the Token receipt. There is no need to specify the image 600 since the file name and placement should already be known by the kiosk 300. However, the system may be configured to require that the service provider specifies the image 600 and its location (e.g. header, footer, margin, specific box, etc.). This could be done for redundancy purposes (in which case the kiosk 300 could either print the image 600 based on the stored information or based on the received information depending on the design choice) or it could be done to allow services, which are not specific to the kiosk 300 to utilize the graphical receipt capabilities. Further, in the event the image 600 is an image of a coupon, this requirement could be used to update the coupon.

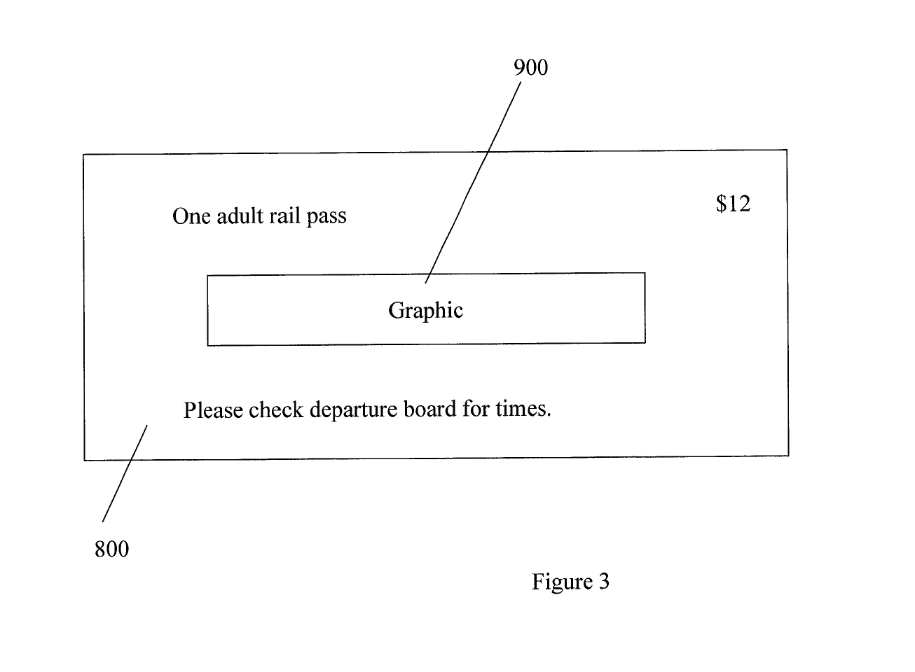

If the receipt is a Raw receipt (one in which the content provider has full or partial control over the printed appearance), kiosk 300 receives the Raw data (including character data and printer control codes) and prints the image 900 (FIG. 3) in the location indicated by the received Raw data. Since there may be no limitation on the placement of the image (or it may be slightly limited, but less so than for a Token receipt), the location is included with the Raw data.

When the image 600/900 is loaded by the kiosk 300, it may be converted to grayscale, then dithered to black-and-white (e.g. using the Floyd-Steinberg approach or some other dithering approach) to create the illusion of varying gray shades. The matrix of black-and-white pixels is packed into the printers bit-image format and sent to the printer 500 for printing.

Aside from being able to print receipts, the printer may be employed to generate and print coupons that include images. As with the printed receipts, there may be primarily two types of coupons, Token and Raw. Those skilled in the art will recognize that it is possible to have a hybrid of these two for both the coupon and receipts, and that such a hybrid would be covered by the present invention. However, a hybrid will not be discussed further as it would simply be a partial restatement of each of the described embodiments.

The kiosk 300 may contain software that monitors web sites visited, on-line transactions which transpire, and the user session in general (collectively referred to as transaction information). If the software determines that a match exists between an aspect of the user session and an element from database 200 the software may download the remainder of the information in the database 200 relating to that match and print a Token coupon. For example, the software may download the specific advertiser, the coupon amount, and the graphical information. If the graphical information is a URL, the software may download the graphic from the appropriate web page. Once the image has been downloaded, the software may activate the kiosk printer 500 so that it prints the coupon 800 (FIG. 3) containing the name of the advertiser, the coupon amount, and the one or more images 900. Additionally, the kiosk 300 may contact the service provider, download Raw data and print the Raw coupon based upon the information provided. The methods for printing the coupons (e.g. Token vs. Raw) are the same as those for printing the receipts.

It is possible that overlap may occur in the database elements. For example, an Internet search of the word “shoe” may match with several advertisers in the database 200, such as Foot Locker™, Payless Shoes™, Nike™, Kenneth Cole™, etc. The system may be configured to print coupons for all of the matches, some of the matches or none of the matches. For example, the system may be configured to print match information according to a structured hierarchy, or it may default to further requirements. The system may also be configured to only print coupons for a particular set of advertisers. For example, a user may type in “shoes” into a search engine, generating a match to Foot Locker™ and other shoe advertisers. However, the software may be configured to print coupons only for FootLocker™, for example.

In an embodiment, the kiosk 300 may be replaced by a Point-Of-Sale (POS) terminal, which collects and stores retail sales data. The database 200, and the images can be deployed with the POS terminal. Upon completion of a transaction, the POS terminal processes the transaction, sends the results to the service provider and receives the receipt details (transaction information). In a retail grocery setting, for example, receipt details can be provided as the goods (e.g. coffee, etc.) are being purchased. The POS terminal produces a receipt 700 (FIG. 2) with the included image, which for coffee could be a geographically local coffee shop, a merchant that may be of interest to the consumer, or an image as basic as the logo of the grocery store.

The POS terminal may provide a coupon generator capability, implemented through software modules, for execution by the POS terminal's or kiosk's 300 microprocessor circuitry. The coupon generator communicates with an input port that receives and processes purchase information relating to a transaction. Upon processing of the purchase information, the coupon generator provides a responsive index pointer that correlates to a coupon field of the service provider information. The image database 200 provides access to coupon fields for the storage and retrieval of coupon images. The coupon generator incorporates a related, or designated, coupon image with the purchase information for transmission to an output port for producing a receipt for the consumer.

The following claims are intended to cover all of the generic and specific features of the invention described herein, and all statements of the scope of the invention which, as a matter of language, might be said to fall there between.

Having described the invention what is claimed is:

1. A method of printing a receipt which includes an image, comprising:
downloading transaction information;
retrieving an image associated with said transaction information;
converting said image into a pixels matrix representation;
printing at least one scan line by selectively printing pixels corresponding to said pixel matrix representation.

2. The method of printing a receipt according to claim 1 wherein said transaction information includes image information.

3. The method of printing a receipt according to claim 1 further comprising:
converting said image into a dithered black-and-white pixel matrix representation.

4. The method of printing a receipt according to claim 1 further comprising:
converting said image into a grey scale representation.

5. The method of printing a receipt according to claim 2 wherein said image information is a file name.

6. The method of printing a receipt according to claim 5 where in said retrieving said image includes downloading said image from a remote location.

7. The method of printing a receipt according to claim 2 wherein said image information is a Universal Resource Locator (URL).

8. The method of printing a receipt according to claim 7 wherein said retrieving said image includes downloading said image from a remote location identified by said URL.

9. The method of printing a receipt according to claim 1 wherein said scan line is printed in a predetermined location on said receipt.

10. A method of printing a coupon which includes an image, comprising:
monitoring transaction information;
retrieving an image associated with said transaction information;
converting said image into a pixel matrix representation; and,
printing at leasr one scan line by selectively printing pixels corresponding to said pixel matrix representation.

11. The method of printing a coupon according to claim 10 further comprising:
comparing said transaction information to a database; and
downloading image information from said database responsive to a match.

12. The method of printing a coupon according to claim 11 further comprising:
converting said image into grayscale.

13. The method of printing a coupon according to claim 12 further comprising:
converting said grayscale image into dithered black-and-white pixels.

14. The method of printing a coupon according to claim 11 wherein said image information is a file name.

15. The method of printing a coupon according to claim 10 wherein said retrieving said image includes downloading said image from a remote location.

16. The method of printing a coupon according to claim 11 wherein said image information is a Uniform Resource Locator (URL).

17. The method of printing a coupon according to claim 16 wherein said retrieving said image includes downloading said image from a remote location identified by said URL.

18. The method of printing a coupon according to claim 11 wherein said scan line is printed in a predetermined location on said receipt.

19. A system for printing a coupon or receipt which includes an image, comprising:
a work station capable of connecting to a network;
a printer in electrical communication with said work station; and,
software loaded on said work station, wherein said software is configured to download image information from a remote location; and,
convert an image associated with said image information into a pixel matrix representation; and,
wherein said printer is configured to print at least one scan line by selectively printing pixels corresponding to said pixel matrix representation.

20. The system according to claim 19 wherein said network includes the Internet.

21. The system according to claim 19 wherein said software is further configured to convert said image into a black-and-white representation.

22. The system according to claim 19 wherein said work station includes a kiosk.

23. The system according to claim 19 wherein said work station includes a Point-Of-Sale (POS) terminal.

24. Apparatus for receipt generation comprising:
a coupon generator coupled to an input port of said apparatus, to receive and process purchase information relating to a transaction, said coupon generator providing at least one index pointer responsive to said purchase information; and,
a coupon image database having accessible a plurality of coupon fields for storage and retrieval of coupon images, said coupon generator incorporating a related coupon image with said purchase information for transmission to an output port.

25. A method of advertising by printing an image on a receipt or coupon, the method comprising:
downloading image information from a database;
retrieving an image associated with said image information;
converting said image into grayscale;
converting said grayscale image into dithered black-and-white pixels;
converting said dithered pixels into a pixel matrix representation; and,
printing at least one scan line by selectively printing pixels corresponding to said pixel matrix representation.

26. The method of advertising according to claim 25 further comprising:
monitoring transaction information and comparing said monitored information to information in said database; and
determining said image information to download based upon said comparison.
